(19) United States
(12) Patent Application Publication
(10) Pub. No.: US 2002/0156860 A1
(43) Pub. Date: Oct. 24, 2002

(54) Personal server system

(76) Inventors: Alan D. Finke, Pleasanton, CA (US); John E. Buchbinder, Orinda, CA (US)

Correspondence Address: Paul Tomita, DERGOSITS & NOAH LLP, Suite 1450, Four Embarcadero Center, San Francisco, CA, 94111, US

(21) Appl. No.: 10/163,943

(22) Filed: Jun. 5, 2002

Related U.S. Application Data
(63) Continuation-in-part of application No. 10/077,105, filed on Feb. 15, 2002.
Application No. 10/077,105 is a continuation-in-part of application No. 09/513,550, filed on Feb. 25, 2000, now abandoned.

(51) Int. Cl. G06F 15/16; G06F 15/173

(52) U.S. Cl. 709/208; 709/223

(57) ABSTRACT

The present invention is for an improved system which integrates the electric objects in a home, office or other space into a control and monitoring network. The possible networked objects include: VCRs, TVs, home entertainment systems, kitchen appliances, light fixtures, pools, alarms systems, environmental controls and weather stations. The inventive system includes a server that controls and monitors functions of networked objects and a remote control which allows a user to enter commands and receive information from the server. The remote device is operable from within the networked space (e.g., in and around the home), and from outside of it (via a modem connection, the Internet, or some other type of external access).

### CROSS-REFERENCE TO RELATED APPLICATIONS

This application is a continuation-in-part application of U.S. application Ser. No. 10/077,105, entitled “PERSONAL SERVER TECHNOLOGY WITH FIREWALL DETECTION AND PENETRATION”, filed on Feb. 15, 2002 which is a continuation-in-part application of U.S. application Ser. No. 09/513,550, entitled “PERSONAL SERVER TECHNOLOGY”, filed on Feb. 25, 2000.

### FIELD OF THE INVENTION

The present invention is a connectivity solution for use in the home, office and other locations. It comprises a server-like apparatus that integrates home appliances, entertainment systems and other objects into a coordinated wireless control and monitoring network. A remote client is implemented by the user to control and monitor these objects via the functioning of the server-like apparatus. The server-like apparatus is also connected to other networks, such as the Internet. The remote device presents the user with a powerful, easy-to-use interface environment that intuitively maps to the objects on the network. The present invention thus implements an automated, intelligent, seamlessly connected “home of the future.”

### DESCRIPTION OF RELATED ART

There are numerous systems in the current art are used to monitor and control electronic appliances and other objects in the home and office. Such systems are limited almost exclusively to “remote control”—the use of hand-held device to send instructions to and receive information from one, or at most a few, local objects. One example of this is the standard VCR remote, which operates on infrared wavelengths (“IR”). A VCR remote is typically used to program recording parameters into a VCR and to operate the VCR in real-time. Similar remotes exist for TVs, CD players and other appliances. Lights and other household fixtures can also be controlled by remote, usually by installation of a component that allows for simple commands such as on/off and dimming.

However, the state of remote control in the current art is nascent. Some objects such as VCRs and CD players usually have remote control devices, but many do not. Even among the objects that do have remote control, such objects are not controlled through integrated networks. In fact, the notion of connectivity system or solution hardly applies to the state of the current art. Of the relatively few objects in a present-day home or office that can be controlled by remote, each one generally requires a separate remote control device. Sometimes, a handful of objects can be controlled with a single remote (e.g., CD player, amplifier and tuner all from a single manufacturer that are standardized to a single remote, or the “universal” remote that can control a large number of TVs and VCRs).

The current art does have home control systems that allow a user to control lights and other fixtures throughout the household. While appearing to be more of a true “control network,” these systems still exhibit only rudimentary control over and feedback from objects that are connected to the network. In addition, these systems are difficult to implement, and do not offer the power and flexibility of a programmable, software-based network. They also cannot be controlled and monitored from outside the home via network and Internet connections.

The true networks that do exist in the current art are essentially limited to information exchange. For instance, U.S. Pat. No. 5,809,415, issued to Rossmann, which is herein incorporated by reference in its entirety, describes a two-way, portable data-communication device that allows a user access to a wide-area network such as the Internet. Such inventions are limited in the opposite way that home-control and remote-control systems are limited. The former cannot manipulate and monitor the physical world, at least not to any appreciable degree, while the latter lack the information, control and integration aspects of a true network.

For these reasons, among others, there is a need in the art for a true network that can bring a large number of objects under the control of a single, integrated connectivity solution. This solution would ideally be flexible enough to be programmed for different network configurations and settings with ease, and be powerful enough to allow the user to have precise control and perception of the objects in the network through the metaphor of an intuitive user interface.

### SUMMARY OF THE INVENTION

The present invention offers such an integrated connectivity solution for remote control of household and office devices. It comprises a software-based network that can perform information-rich tasks and that incorporates sophisticated object monitoring and control into the network. The present invention consists of a server-like apparatus (“Personal Server”) that controls a network, frequently wireless, in the home or office. The Personal Server is accessed through a Remote Device, generally a hand-held, personal digital assistant (“PDA”) or a PC running an Internet browser. PALM O/S™ devices such as the a PALM PILOT™, PALM III™ and PALM IV™, and WINDOWS CE™ devices such as the PHILIPS NINO™, CASIO CASSIOPEIA™ and HP JORDANA™ are common PDAs that are readily adaptable for use with the present invention. Internet Explorer and Netscape Navigator are examples of Internet browsers that are readily adaptable for use with the present invention.

The present invention allows users to control and monitor various network integrated objects. These functions can be accomplished from within the home or office, or from the outside world through a dial-up connection, network, or the Internet, or other means. Remote information tasks, such as file exchange, computational activity and financial transactions can also be carried out by the Personal Server, using the Remote Client as the interface. Third parties, such as alarm companies and police departments, can be given full or partial access to the monitoring and control functions of the Personal Server.

The purpose and advantages of the present invention will be apparent to those skilled in the art from the following detailed description in conjunction with the appended drawings, which show typical embodiments of the invention.

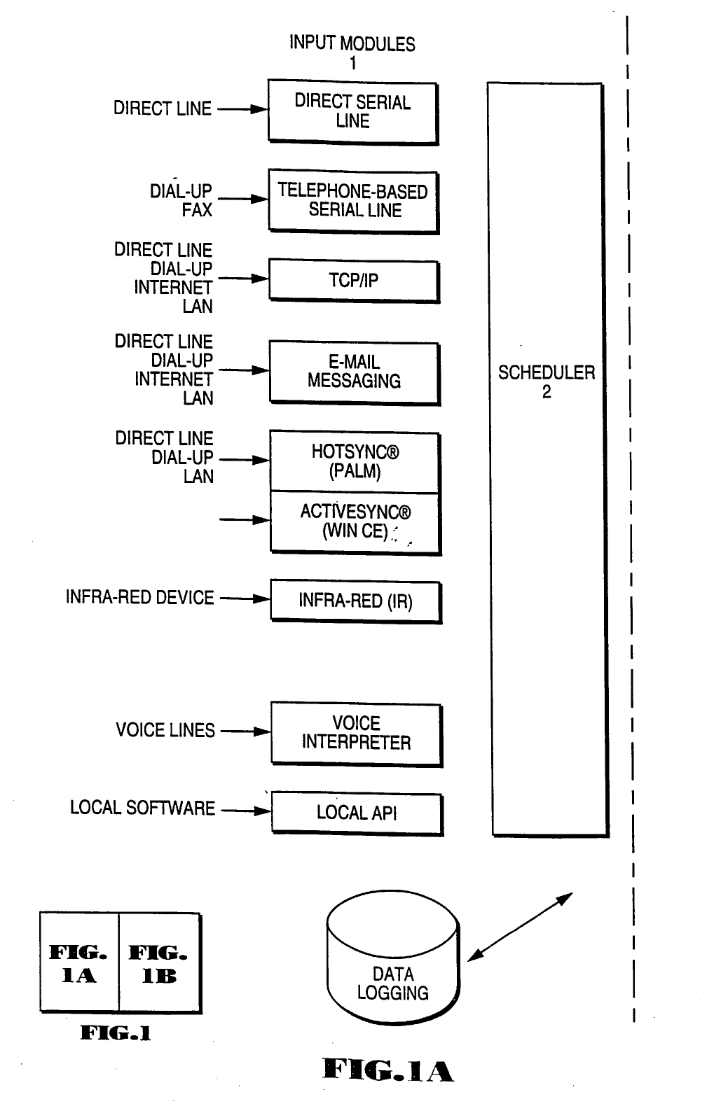

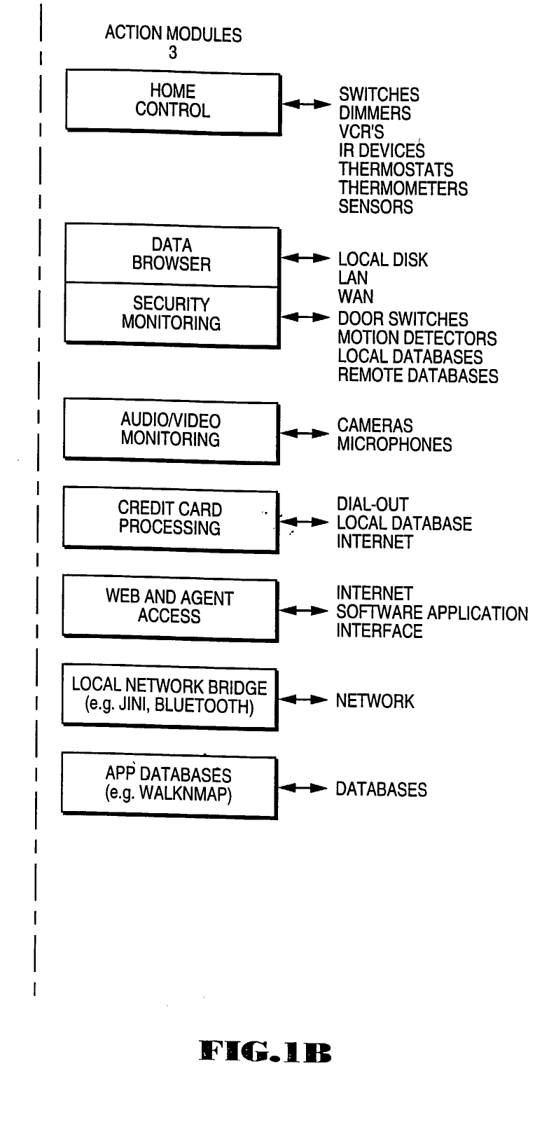

FIGS. 1A and 1B illustrate a preferred embodiment of the Personal Server, including Action Modules 1, Scheduler/Router 2 and Input Modules 3. Examples of Input and Output Modules, including typical connection objects/protocols, are included.

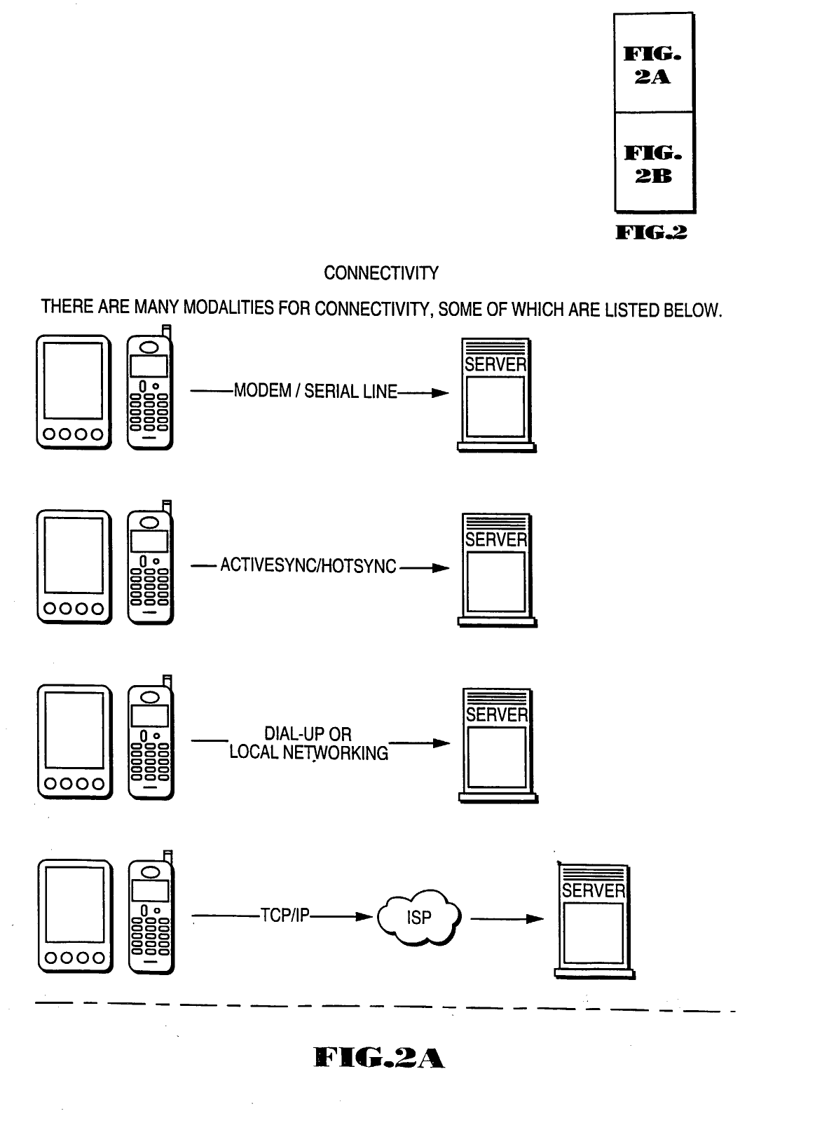

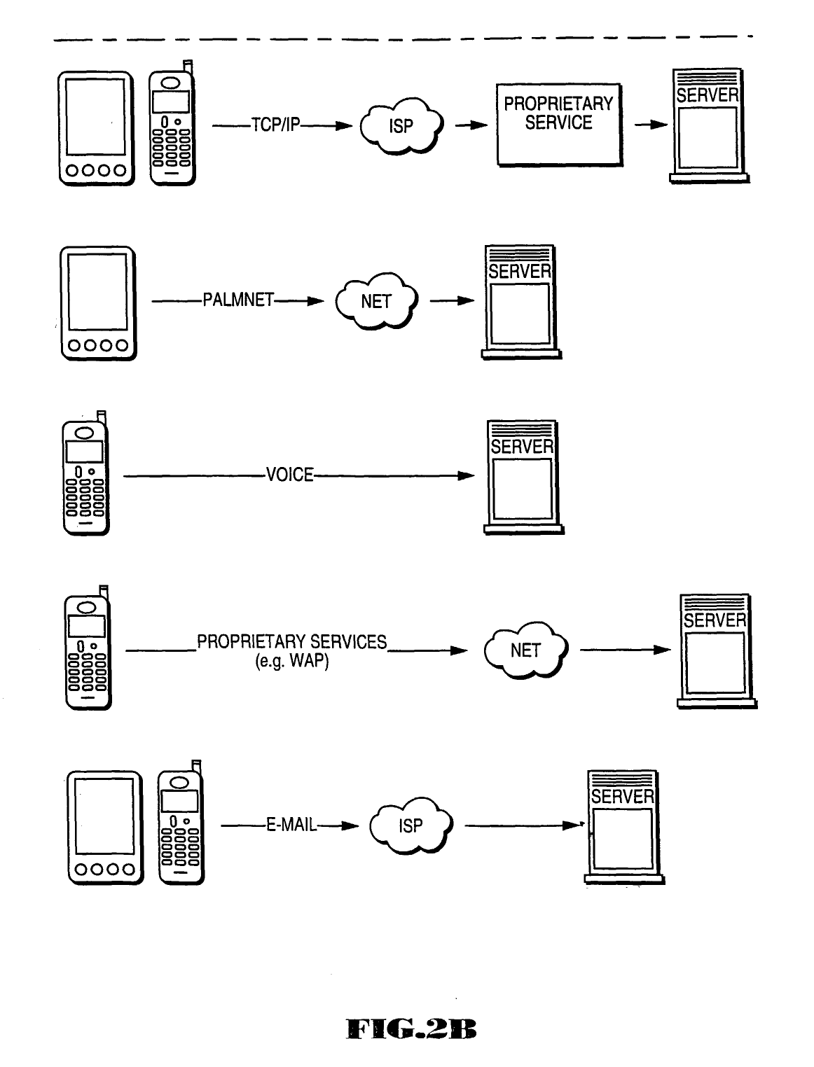

FIGS. 2A and 2B illustrate some examples of the physical connection and data transfer protocols that can be used between the Remote Client and the Personal Server.

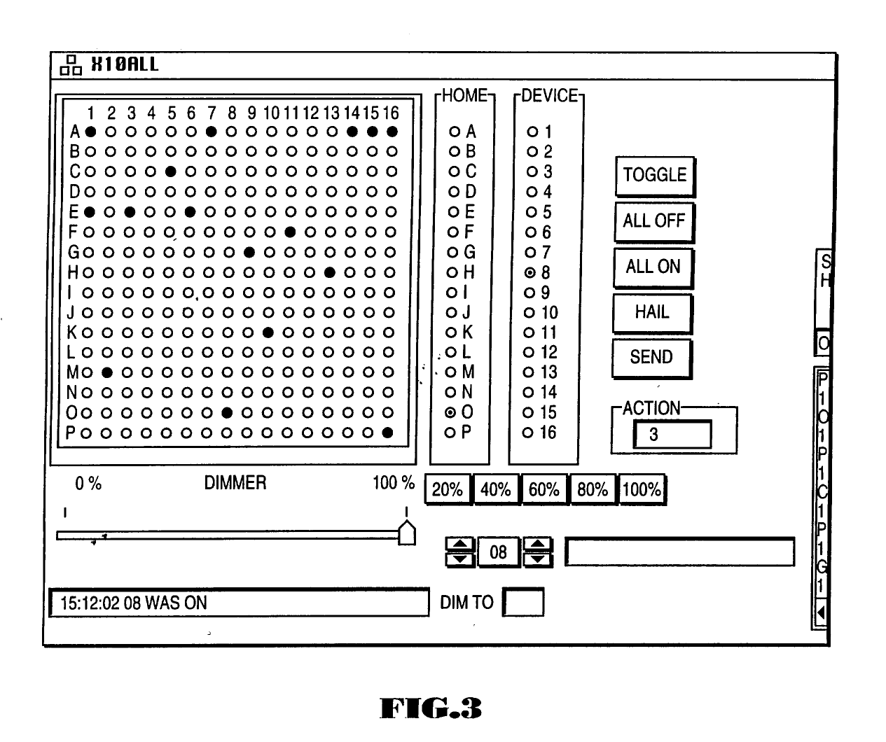

FIG. 3 shows a control panel that is used to configure the network of objects on the Personal Server, in this case, those objects that are on an ACTIVEHOME™ X10 system.

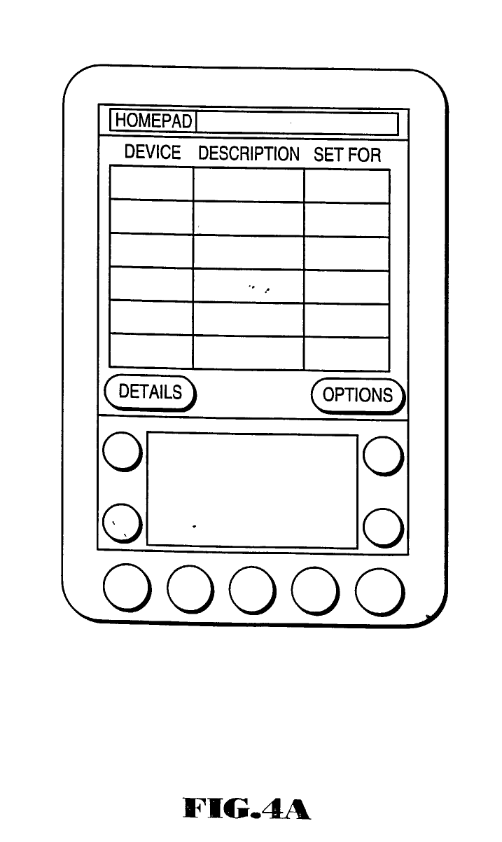

FIGS. 4A and 4B show an example of a screen on the Remote Client interface used with the present invention, in this case, Home Pad. Home Pad is used to control home appliances and fixtures.

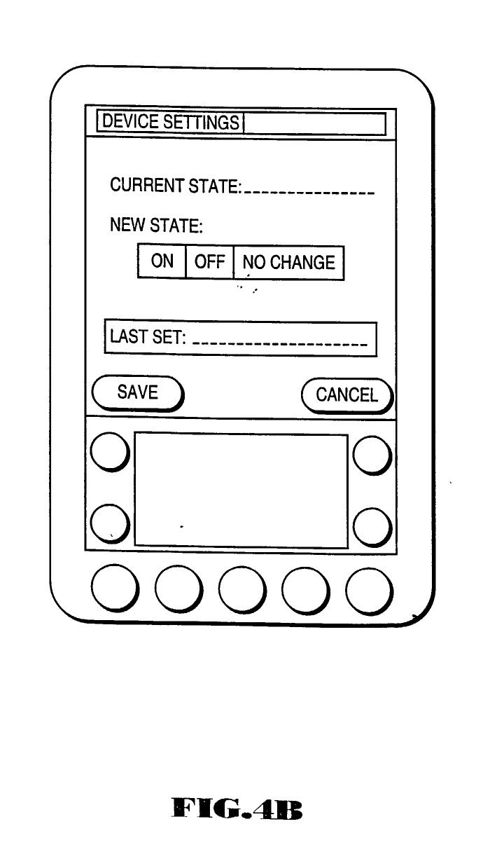

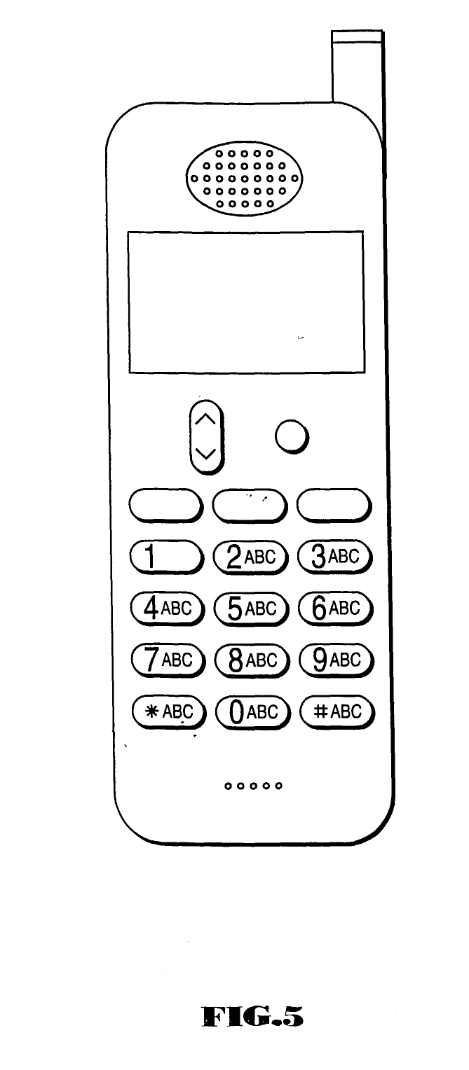

FIG. 5 shows an embodiment of Home Pad on a more graphically limited remote client, namely, a cell phone.

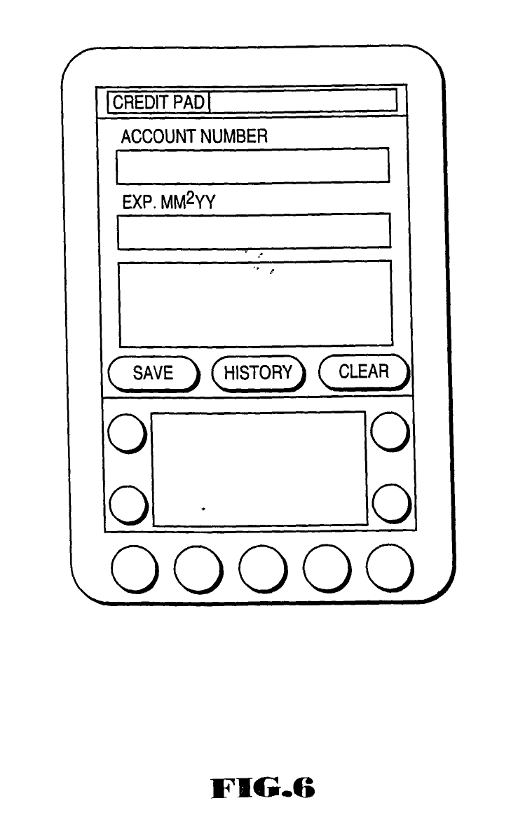

FIG. 6 shows an example of a screen on the Remote client interface used with the present invention, in this case, Credit Pad. Credit Pad is used to verify and charge credit card numbers.

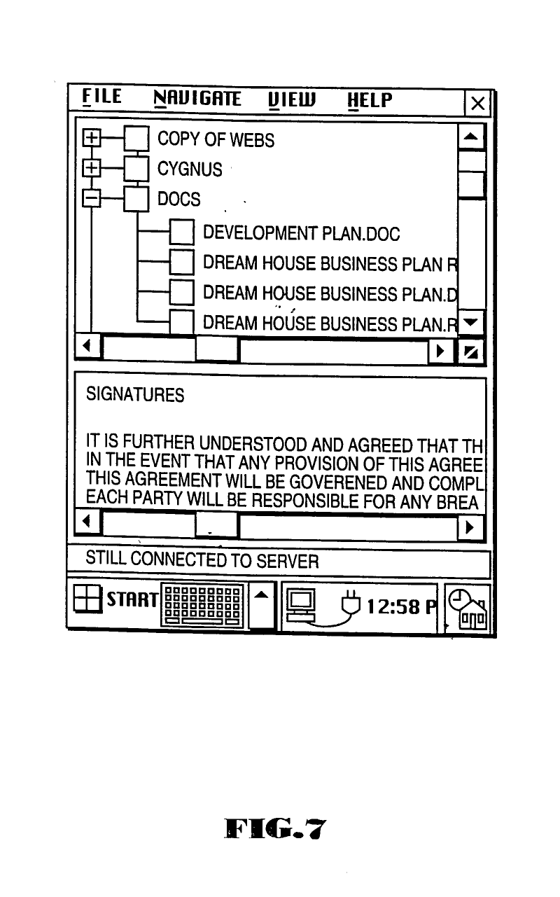

FIG. 7 shows an example of a screen on the Remote Client interface used with the present invention, in this case, File Retriever. File Retriever is used to retrieve files from the Personal Server.

### DETAILED DESCRIPTION OF THE PREFERRED EMBODIMENTS

This section describes a preferred embodiment of the Personal Server Technology. Many other embodiments are obvious to one of ordinary skill in the art.

Reference will now be made in detail to preferred embodiments of the invention, so as to enable a person skilled in the art to make and use the invention in the context of a particular application. It is understood that such embodiments are not intended to limit the invention to one preferred embodiment or application. On the contrary, the invention is intended to cover alternatives, modifications, and equivalents. Various modifications to the present invention will be readily apparent to one of ordinary sill in the art, and can be made to the described embodiment within the spirit and scope of the invention as defined by the appended claims.

In a preferred embodiment, the core of the present invention is a server-like apparatus (“Personal Server”). The Personal Server, in a preferred embodiment, comprises software run on a general-purpose computer. The computer can be a server, workstation or any other type of computer, but in the described embodiment, the computer is a desktop PC. In other embodiments, the Personal Server comprises hardware specifically designed for the invention, or a combination of hardware and computer software. The software can be a component bought off the shelf, a component specially designed for a particular home or office, a plug-in to a software developer's kit, or part of a larger proprietary system, among other embodiments. The software of the Personal Server is typically written in C, C++ or Java. The Personal Server is designed to have a robust and flexible interface that makes it easy for developers to develop input and Action Modules that operate with the present invention.

1. Software Architecture

a. Personal Server

The following is a preferred embodiment of the software architecture of the present invention. FIG. 1 illustrates a further preferred embodiment, in detail.

The Personal Server has a software architecture that consists of the following components: (1) Input Modules, (2) a core Scheduler/Router with data monitoring and logging capabilities and (3) Action Modules. The Input and Action Modules are self-contained code libraries designed to be detected by the Scheduler/Router and connected at run-time. This allows developers and consultants to develop additional modules, even for specific individual users, to fit those users needs. In particular, as new forms communication and activity are developed through technological development, commercial innovation and commercial imagination, new types of modules will be developed. Such modules can be added to the Personal Server by direct installation or by downloading on an ad-hoc basis from remote sources. They can also be dynamically added to individual installations of the Personal Server to minimize service interruption.

Input modules serve to connect a user's Remote Device to the personal Server, but they can be designed for other modes of communication as well. Various types of physical connections and data-transfer protocols can be used, as illustrated in FIG. 2. At the time of connection, the Remote Device sends the information entered by the user to an Input Module or modules. This information is translated into a “Message” by the Input Module. Messages generally contain information on the user, the Remote Device, the target Action Module and data specifics. The Input Module then passes the message to the Scheduler/Router, which logs it into a database, processes it as necessary, and passes the Message again to the appropriate Action Module. The Action Module then performs the requested actions. After the action has been completed, the Action Module creates a second Message containing information on whether the action has been successfully completed, any additional information requested by the remote device, and whether additional instructions are needed. The Action Module passes the Message to the Scheduler/Router, which logs it, processes it as necessary, and passes it, if necessary, to the Input Module that communicates its contents to the Remote Device. Additional messages not specifically mentioned may be created and sent as particularly in other embodiments.

At start-up, the Scheduler/Router loads the existing Input and Action Modules and monitors them for activity. As noted, the Scheduler/Router processes and relays Messages between the Input and Action Modules. It maintains information on user authentication and security information, as well as logs of the Messages. In a preferred embodiment, a utility module is written as an adjunct to the Scheduler/Router, which allows the user to enter settings. The utility module will generally have a control-panel type interface to aid in configuring new user preferences and new modules.

b. Input Modules

As described in the section above, Input Modules serve as “connection points” between the Personal Server and the Remote Device. The various Input Modules in place with a particular embodiment of the Personal Server are designed to handle various connectivity and data-transfer protocols (some examples of which are listed in FIG. 2). In a preferred embodiment, TCP/IP protocol, serial protocol, proprietary PDA protocols such as HOTSYNC™ (for PALM OS™ devices) and ACTIVESYNC™ (for WINDOWS CE™ devices) are among these protocols. An Input Module communicates with a Remote Device by synchronizing with the Remote Device, receiving and interpreting Messages from it, and then pass the messages on to the Scheduler/Router. Messages are sent from the Scheduler/Router to the Remote Device as well. The Input Modules also serve to encrypt and decrypt Messages, as necessary. New input modules and message protocols can be developed by one of ordinary skill in the art as new technologies, in particular O/S device types, are developed.

c. Action Modules

The Action Modules are the software objects that actually carry out instructions specified by the user and obtain status information from the networked objects. Because of the wide variety of specific actions they carry out, they will often include their own databases to assist in their functions. Some Action Modules will have their own connectivity to the Web and to other communication lines. An Action Module may be connected to a third party or parties, to the Internet, to other computer systems, or to other networks (even other Personal Server networks).

d. Messages

In a preferred embodiment Input Module Messages comprise: user information, intended Action Module or modules, message length, time stamp and data specifics. The data specifics contain specific commands to the Action Module or modules such as requests for state information.

e. Remote Client/Remote Device

The Remote Client is the user's interface and architecture for the Personal Server. It resides on the Remote Device as a data-gathering/presentation medium. The Remote Device, in a preferred embodiment, is based in a handheld PDA such as PALM O/S™ or WINDOWS CE™ device. Since such handheld devices are generally limited in terms of processing power, memory and display capabilities, the Remote Client is designed with these limitations in mind. Therefore, in a preferred embodiment, the software architecture of the present invention relies most heavily on the Personal Server itself, rather than on the Remote Client. In some cases, a laptop or even desktop computer will act as the Remote Device, often connected through a network, such as the Internet, but even in these cases, the degree of input available from the computer may be limited.

The Remote Client presents an environment that precisely maps to the network of objects to be controlled through the Personal Server, thus allowing seamless control and perception over the network. The Remote Client has the appropriate interfaces, which communicate with the Input Modules of the Personal Server. The Remote Client is generally designed with the most minimal interface environment that nonetheless remains clear and intuitive to the user. FIGS. 4-6 illustrate sample Remote Client environments, including Home Pad, Credit Pad and File Retriever (see “Brief Description of Drawings”). While somewhat less complex than an environment on the Personal Server itself, such as the X10 control interface of FIG. 3, Remote Client environments nonetheless remain robust and easy to use.

The Remote Client also generally uses the minimum amount of the encryption and authentication necessary to preserve security. Remote Devices, particularly third-party Remote Devices, will generally be programmed to operate as the Remote Client. Input Modules can also be configured to work with software and security measures that are already present on Remote Devices. Some Remote Devices will be adapted with additional hardware to operate as the Remote Client, and some will be manufactured specifically for use with the present invention.

Remote Devices may use a variety of physical connection and data transfer protocols to communicate with the Personal Server, some examples of which are illustrated in FIG. 2. Typically more than one protocol will be available, depending on where the user and the Remote Device happen to be at the time of linking. The following is another way of categorizing the types of connections.

1. Through the same wireless network that is used to control objects in the home or office (used when the user is in or near that home or office)

2. Through a different wireless network

3. Through a direct wire-based or wireless connection, such as a serial computer interface (used when the Remote Device is “plugged-into” the Personal Server for data transfer or programming

4. Through a dial-in modem connection

5. Through the Internet or other Wide-Area network

6. Mediated by an intermediate server.

7. Any combination of the above.

Traditional phone lines, leased lines and satellite connections are among the pipes that can be used to support these physical connections. In some cases, it will be desirable for the user to authorize third-party access to some or all of the control and monitoring systems of the Personal Server. For instance, a user may allow an alarm company to monitor the alarm system. He may also wish to give some access to a family member or friend if the user is on vacation or otherwise indisposed.

f. Overall

The following flowchart illustrates, as a preferred embodiment, the method of using a device constructed in accordance with the present invention to carry out a typical task, such as programming a VCR.

1. The user enters information concerning the desired action into the Remote Device

2. The Remote Device stores the information

3. The user synchronizes the Remote Device by indicating to the Remote Client that the information should be transmitted.

4. The Remote Device dials into the Personal Server via cellular modem

5. The Personal Server Input Module receives the phone call

6. The Input Module uploads the information from the Remote Device, creates a Message, and alerts the Scheduler/Router

7. The Scheduler/Router determines that the Message for the VCR Action Module

8. The Scheduler/Router passes the message to the VCR Action Module, which in turn sends the instructions to the VCR

9. The VCR Action Module sends a new Message to the Schedule/Router, confirming that the action was or was not taken, among other status details

10. The Scheduler/Router logs, processes and passes the new Message to the appropriate Input Module

11. The Input Module responds to the Remote Device, if necessary, reestablishing the connection if need be

12. The Remote Device displays relevant status information to the user

13. The Input module hangs up the modem connection

This flow chart embodiment can be applied, with modifications, to the control and monitoring of other objects and other embodiments.

2. Functionality

The Personal Server is designed to carry out three functions, among others: control, monitoring and remote information tasks. Other functions are obvious to one of ordinary sill in the art. The Personal Server is typically used to control and monitor the following types of objects: remote-ready objects, non-remote-ready objects and other objects. Many objects will have both control and monitoring aspects to them, (e.g. “is the porch light on?” “turn on the porch light”), though some objects will have relatively more of one type of functionality than the other. As an example, VCR's have relatively more control functions, relating to programming the VCR, than monitoring/status functions.

Typically, the Personal Server and its objects will operate on a wide area network (“WAN”), local area network (“LAN”), virtual private network (“VPN”), or personal area network (“PAN”). In a preferred embodiment, Intel's BLUETOOTH™ is the hardware standard used to put together the network and TCP/IP is the protocol. Many other hardware and protocol implementation are obvious to one of ordinary skill in the art. In general, communication nodes will be used to broadcast the network signals to objects on the network. For example, in one IR embodiment, HOUSELINCE™ stations are used with the present invention to broadcast the signals.

a. Remote-Ready Objects

Remote ready-objects are devices that are already remote-capable. These objects typically include VCRs, TVs, CD players, thermostats, industrial monitoring and control equipment, and other sophisticated electronic devices that normally come with remote capability (generally using infra-red signals, in the current art). The Personal Server takes advantage of such remote capability to communicate with these devices. Many of these objects use standardized communication protocols, which makes it a straightforward matter to communicate with these devices (“universal” remotes, for instance, take advantage of these standards). The Personal Server can be programmed with additional Input Modules to allow for communication with non-standard objects, however. Input Modules may be developed by value-added providers to enable the Personal Server to communicate with new and non-standard devices as they are developed.

As further illustration, consider the activity of programming a VCR, discussed in the above section on overall architecture. The user, could, of course, program the VCR directly via the VCR console or remote. The present invention makes it a simple matter to program the VCR from the computer that runs the Personal Server. The user will typically enter the time and channel to record, or else a code corresponding to a program (such as VCR-PLUS™ code). In a preferred embodiment, the user is also able to enter the name of the program, and the Personal Server, by interacting with a database or data source (such as one on the Internet), determines the program specifics. The Personal Server is sophisticated enough in its architecture to prompt the user if there is a problem with the information entered, or if it cannot complete the task (for instance, if the VCR is already programmed for another program at the same time). It will also prompt the user with other status information, when it is appropriate.

Of course, the user generally will wish to program the VCR from a Remote Device rather than from the Personal Server itself. The present invention, by connecting the Remote Device to the Personal Server in a seamless fashion, makes this effectively the same task.

b. Non-Remote-Ready-Objects

Non-remote-ready objects are those objects that typically are not remote capable. Examples of these objects include microwave ovens, dishwashers, toasters and coffee makers. Increasingly, such devices are being manufactured remote-ready. As Personal Servers become increasingly common, this trend will likely continue. For objects that are not remote-ready, a user will be able to adapt the objects for remote use with additional hardware. At the very least, such objects and be controlled with simple commands by installing remote switches such as ACTIVEHOME X10™ units (see “Other objects,” below), or, failing that, at least simple on/off switches.

The programming of a non-remote-ready device is similar in implementation to the programming of a VCR outlined above. One difference though is that non-remote-ready objects tend to be more dependent on status in order to function in an appropriate manner. For instance, there should be coffee in the coffee maker or food in the microwave oven before the Personal Server activates these objects. It is partially for this reason that such objects have not been as readily adapted for remote use as some others have. Leaving dirty clothes in a washing machine and washing them later is not so common. Nonetheless, the ability to do so must be convenient in some cases, such as turning a coffee machine on in the morning. As Personal Servers become more common, users will wish to take advantage of these conveniences, and thus more objects not envisioned as readily adaptable to remote use will be made remote-ready.

c. Other Objects

There are a number of other objects that can be controlled and monitored with the Personal Server. For example, simple objects such as lighting fixtures can be equipped with ACTIVEHOME X-10™ IR units, which can be used to turn them on and off and to dim them. Much more sophisticated objects, such as pools and Jacuzzis, environmental systems, weather stations and television cameras, among others, can be controlled and monitored with the present invention. Again, the user may well need to adapt these objects for use with the Personal Server by installing hardware attachments.

The types of objects that can be incorporated into the Personal Server system are almost limitless. As one example, the system can be used to detect how many cars are sitting in the garage or driveway through the use of cameras, external sensors or chips embedded in cars. The latter is a particular cheap and simple way of bringing automobiles into the domain of the Personal Server. More sophisticated control features, such as remote car warmers, security systems or ignition devices, will become amenable to the present invention as available technology improves, and as users, vendors and inventors become more accustomed to and imaginative about such uses. One of ordinary skill in the art can imagine boundless examples. In this way, the present invention provides a broad basis for future technical development.

d. Remote Information Tasks

One of ordinary skill in the art will appreciate that the remote information uses will also proliferate as technology, commercial innovation and commercial imagination develop. One current use is the transfer of computer files, such as video, spreadsheets, word processing documents and figures between the Remote Client and the Personal Server.

These files may be used as part of the various control and monitoring features of the Personal Server, for example, captures or streaming video from household cameras, or they may be entirely unrelated.

Communication can be done continuously, or in bursts, depending on need. Either the Remote Client of the Personal Server, and in some embodiments, objects in the network, can initiate and terminate communications. The user can also manually initiate communication. In one embodiment, the Personal Server can act as a pass-through communications link for the Remote Client.

For instance, the user can surf the Internet remotely from the Remote Device via the Personal Server. Computational tasks and file retrieval can be done in a similar manner. The user can accomplish these tasks in real-time or else send the task to the Personal Server and then end the transmission. At some later time, when the Personal Server has completed the task or requires additional information, the Personal Server request that the communication be reestablished.

One particularly convenient use for the present invention applies to credit-card transactions. Merchants using the current invention can verify credit-card numbers by uploading them from the Remote Device (which will generally have a card reader) to the Personal Server for verification. A credit-card charge can be carried out in a similar manner. Other, transactions, financial and otherwise, are obvious to one of ordinary skill in the art.

Though the foregoing invention has been described in detail for purposes of clarity of understanding, it will be apparent that various changes and modifications may be practiced within the scope of the appended claims. It is therefore intended that the following appended claims be interpreted as including all such alterations, permutations, and equivalents as fall within the spirit and scope of the present invention. All publications and patents herein are incorporated by reference in their entirely.

### REFERENCES

U.S. Pat. No. 5,809,415 “Method and Architecture for an Interactive Two-Way Data Communication Network,” issued to Rossmann.

What is claimed is:

1. A system for remote control of an object and remote access to information comprising:
a remote device having: a microprocessor, a memory, an input device for inputting commands, an integrated visual display for displaying a graphical user interface, a transmitter for transmitting the commands, and a receiver;
a personal server having: a memory and a microprocessor for running a personal server software, wherein the personal server software includes: an input module for receiving the commands from the remote device, a control action module for controlling the object and an information action module for obtaining information, wherein if the command is for controlling the object then the control action module transmits a control signal to the object and if the command is for access to information then the information action module transmits an information request to an object; and
an integrated network which provides communications between the personal server and the object.

2. The system described in claim 1 wherein the personal server software has a monitor action module and if the command is for monitoring the object, the monitor action module transmits a status request to the object.

3. The system described in claim 2 wherein the object transmits a status signal to the monitor action module.

4. The system described in claim 3 wherein the status of the object is displayed on the visual display of the remote device.

5. The system described in claim 1, wherein the visual display of the remote device displays a menu of commands through the graphic user interface.

6. The system described in claim 1 wherein the personal server software further comprises a scheduler which logs the commands from the remote device onto the personal server memory.

7. The system described in claim 1 wherein the personal server software comprises a router for directing the commands from the input module to either the control action module or the information action module.

8. The system described in claim 1 wherein at least a portion of the integrated network is a wireless network.

9. The system described in claim 8 wherein the wireless network is a LAN, WAN or VPN.

10. The system described in claim 8 wherein the wireless network is a PAN.

11. The system described in claim 1 wherein the remote device is a PDA.

12. The system described in claim 1 wherein the remote device is a cellular telephone which communicates with the personal server via a cellular modem connection.

13. The system described in claim 26 wherein the remote device communicates with the personal server via a LAN, a WAN, a VPN or the Internet.

14. The system described in claim 26 wherein the remote device communicates with the personal server via a PAN.

15. The system described in claim 1 wherein the remote device is a PC running an Internet browser.

16. A method for remotely controlling an object and remotely accessing information comprising the steps of:
displaying a graphical user interface on a remote device having random access memory, a visual display, a microprocessor, an input device and a wireless transceiver;
inputting a command through the input device of the remote device;
transmitting the command from the wireless transceiver of the remote device to a personal server;
if the command is for controlling the object then transmitting a control signal to the object through an integrated network;
if the command is for accessing information then transmitting an information request to the object, obtaining the requested information from the object and transmitting the requested information to the remote device.

17. The method described in claim 16 further comprising the steps of:
storing the requested information in the random access memory of the remote device; and
displaying at least a portion of the requested information on the visual display of the remote device.

18. The method described in claim 16 further comprising the steps of:
editing the requested information with the remote device to create modified information;
transmitting the modified information to the object; and
storing the modified information on the object.

19. The method described in claim 16 further comprising steps of:
transmitting a command complete signal to the remote device; and
displaying a command complete message on the visual display of the remote device.

20. The method described in claim 16 further comprising steps of:
performing a task associated with the control signal on the object;
transmitting a command complete signal to the remote device; and
displaying a command complete message on the visual display of the remote device.

21. The method described in claim 16 further comprising steps of:
transmitting a status request to the object through the integrated network;
determining the status of the object;
transmitting a status signal to the remote device; and
displaying a status message on the visual display of the remote device.

22. The method described in claim 16 further comprising steps of:
inputting security information through the input device of the remote device;
transmitting the security information to the personal server; and
verifying the security information before the inputting of the command step.

23. The method described in claim 16 further comprising the steps of:
transmitting a request for additional information to the remote device if the command does not include all information required to form the control signal; and
displaying a message indicating that additional information is required on the visual display of the remote device.
